(19) United States
(12) Patent Application Publication
(10) Pub. No.: US 2022/0305603 A1
(43) Pub. Date: Sep. 29, 2022

(54) MOTOR TIMEOUT IN POWER TOOL

(71) Applicant: Snap-on Incorporated, Kenosha, WI (US)

(72) Inventors: Michael T. Rajzer, Kenosha, WI (US); Jason Genz, Kenosha, WI (US); David A. Cyborski, Kenosha, WI (US); Jeremy Zorns, Kenosha, WI (US); Christoffer S. Fox, Kenosha, WI (US); Patrick F. Healy, Kensoha, WI (US)

(73) Assignee: Snap-on Incorporated, Kenosha, WI (US)

(21) Appl. No.: 17/694,218

(22) Filed: Mar. 14, 2022

Related U.S. Application Data
(60) Provisional application No. 63/165,002, filed on Mar. 23, 2021.

(51) Int. Cl. B23Q 17/09; B25F 5/00; B25F 5/02

(52) U.S. Cl. CPC B23Q 17/0961; B25F 5/001; B25F 5/02

(57) ABSTRACT

The present invention relates to a motor timeout of a power tool. When a trigger of the tool is unintentionally actuated, power is provided to a motor of the tool to cause an output assembly of the tool to operate. This can be problematic when the tool is being stored. To address this situation, the tool initiates or starts a motor timer when the motor is running at any nonzero speed. If the trigger remains continuously actuated, with the motor running at any nonzero speed, and the motor timer reaches a threshold limit, the tool ceases or discontinues to allow power to be provided to the motor, thereby shutting off the motor. This reduces the power source from being unintentionally discharged, and the chance of the tool creating a situation where the output assembly can unintentionally cause damage to the storage mechanism or other surroundings.

### CROSS REFERENCES TO RELATED APPLICATIONS

This application claims the benefit of U.S. Provisional Patent Application Ser. No. 63/165,002, filed Mar. 23, 2021, the contents of which are incorporated herein by reference in their entirety.

### TECHNICAL FIELD OF THE INVENTION

The present invention relates generally to power tools, and more particularly to timing out a motor of a power tool.

### BACKGROUND OF THE INVENTION

Power hand tools, such as, for example, motorized ratchet wrenches, impact wrenches, and other drivers, are commonly used in automotive, industrial, and household applications to install and remove threaded fasteners and apply a torque and/or angular displacement to a work piece, such as a threaded fastener, for example. Power hand tools generally include an output member (such as a drive lug or chuck), a trigger switch actuatable by a user, an electric motor contained in a housing, and other components, such as switches, light emitting diodes (LEDs), and batteries, for example.

However, when a power tool is stored in a bag, tool box, vehicle, or other storage mechanism with the battery or other power source inserted, the trigger switch can be unintentionally actuated, causing the motor to turn on and the tool to run while the tool is stored. If the trigger switch is unintentionally actuated, the battery or other power source of the tool can discharge, causing an inconvenience for the user when the user desires to use the tool in the future, or create a situation where the output member of the tool can cause damage to other contents that it is stored with. Some tools have lockout switches that prevent the trigger switch from being unintentionally actuated. However, the lockout switch requires the user to activate this lockout switch before storage. If the user fails to activate the lockout switch, the problem still exists.

### SUMMARY OF THE INVENTION

The present invention relates broadly to a motor timeout of a power tool. The tool includes a tool housing, an output assembly (such as a ratchet head assembly) adapted to provide torque to a work piece, a trigger, a motor housed in the housing, an indicator, a controller, and a power source. When the trigger is unintentionally actuated, such as, for example, when the tool is placed in a storage bag, power is provided to the motor to cause the output assembly to operate. In this situation, the present invention determines that the motor is running at any nonzero speed or the trigger is otherwise unintentionally actuated, and initiates or starts a motor timer feature. If the trigger remains continuously actuated, with the motor running at any nonzero speed or the trigger is otherwise unintentionally actuated, and the motor timer reaches a preset threshold limit (such as, for example, 2 minutes), the tool turns off or discontinues to allow power to be provided to the motor, thereby shutting off the motor. The tool may also activate the indicator to indicate a fault to the user, thereby indicating that the trigger was unintentionally actuated. After a period of time (such as, for example, 5 to 10 seconds), the indicator may be deactivated to conserve power. When the trigger is released and pulled again or the power source removed, the tool will resume normal operation and the motor timer resets.

Implementation of the present invention reduces the chance of the power source from being unintentionally discharged, when the tool is stored in, for example, a bag, tool box, tool storage cabinet, vehicle, or other storage mechanism. The motor timer and shut-off also reduces the chance of the tool creating a situation where the output assembly can unintentionally cause damage to the storage mechanism or other surroundings.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages, should be readily understood and appreciated.

FIG. 1 is perspective view of an exemplar tool, according to an embodiment of the present invention.

FIGS. 2 and 3 are block component diagrams of electronic components of an exemplar tool, according to embodiments of the present invention.

FIG. 4 is a block diagram of a method of operation of an exemplar tool, according to an embodiment of the present invention.

### DETAILED DESCRIPTION

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention relates broadly to a motor timeout of a power tool. The tool includes a tool housing, an output assembly (such as a ratchet head assembly) adapted to provide torque to a work piece, a trigger, a motor housed in the housing, an indicator, a controller, and a power source. When the trigger is unintentionally actuated, power is provided to the motor to cause the output assembly to operate. In this situation, the present invention determines when the motor is running at any nonzero speed and/or no resistance or torque is applied to the output assembly, or the trigger is otherwise unintentionally actuated, and initiates or starts a motor timer. If the trigger remains continuously actuated, with the motor running at any nonzero speed and/or no resistance or torque applied to the output assembly, or the trigger is otherwise unintentionally actuated, and the motor timer reaches a threshold limit (such as, for example, 2 minutes), the tool ceases or discontinues to allow power to be provided to the motor, thereby shutting off the motor. The tool may also activate the indicator to indicate a fault to the user, thereby indicating that the trigger was unintentionally actuated. After a period of time (such as, for example, 5 to 10 seconds), the indicator may be deactivated to conserve power. When the trigger is released and pulled again or the power source removed, the tool will resume normal operation and the motor timer resets.

Implementation of the present invention reduces the chance of the power source from being unintentionally discharged, when the tool is stored in a bag, tool box, tool storage cabinet, vehicle, or other storage mechanism. The motor timer and shut-off also reduces the chance of the tool creating a situation where the output assembly can unintentionally cause damage to the storage mechanism or other surroundings.

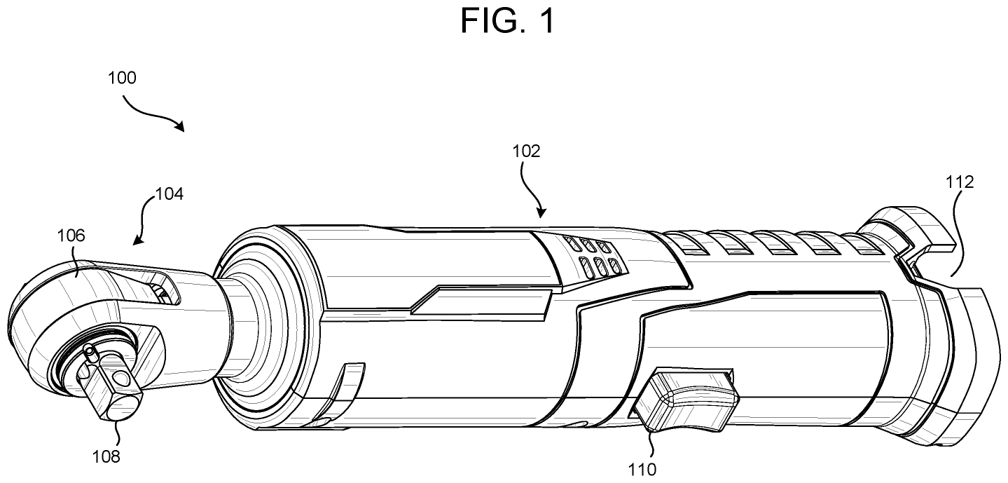

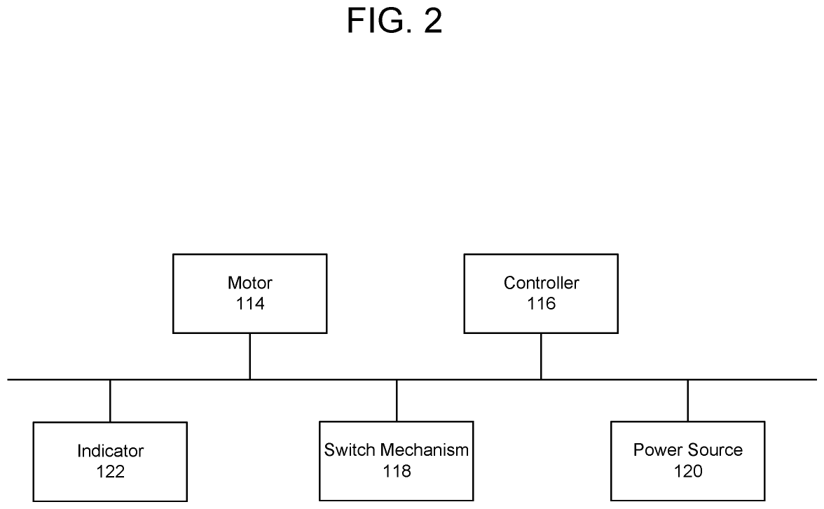

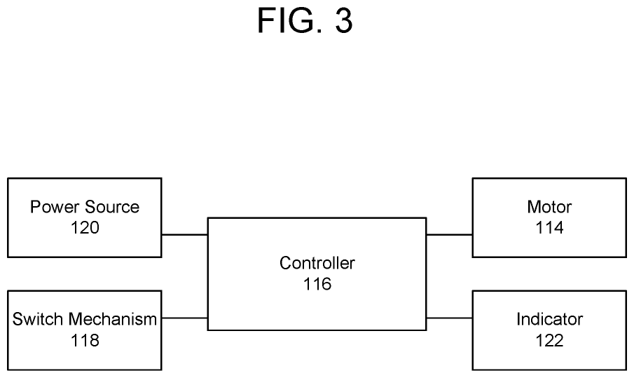

Referring to FIGS. 1-3, a tool 100, such as a cordless ratchet-type tool, includes a main tool housing 102 and output assembly 104 (such as a ratchet head assembly). The tool housing 102 may include first and second housing portions that are coupled together in a clamshell type manner and securely coupled to the output assembly 104. The tool housing 102 may enclose or house an electric motor 114 (shown in FIGS. 2 and 3), controller 116 (shown in FIGS. 2 and 3), a switch assembly 118 (shown in FIGS. 2 and 3), display with buttons for configuring and setting the tool, one or more indicators 122 such as light emitting diodes, and other components for operation of the tool, for example. The tool housing 102 may also include a textured or knurled grip to improve a user's grasp of the tool 100 during use.

The output assembly 104 includes a drive portion 106 including a drive lug 108, for example. The drive lug 108 is adapted to apply torque to a work piece, such as a fastener, via an adapter, bit, or socket coupled to the drive lug 108, such as a bi-directional ratcheting square or hexagonal drive. As illustrated, the drive lug 108 is a “male” connector designed to fit into or matingly engage a female counterpart. However, the drive portion 106 may alternatively include a “female” connector designed to matingly engage a male counterpart. The drive portion 106 may also be structured to directly engage a work piece without requiring coupling to an adapter, bit, or socket. The rotational direction of the drive portion 106/drive lug 108 can be selected by rotation of a selector switch to be either a first or second rotational direction (such as, clockwise or counterclockwise).

The tool 100 also includes a trigger 110 that can be actuated by a user to cause the tool 100 to operate. For example, the user can depress the trigger 110 inwardly to selectively cause power to be drawn from a power source 120 and cause a motor 114 to provide torque to the output assembly 104 and cause the drive lug 108 to rotate in a desired rotational direction. The trigger 110 may also be operably coupled to a switch mechanism 118 that is adapted to cause power to be supplied from the power source 120 to the motor 114 when the trigger 110 is actuated. Any suitable trigger 110 or switch can be implemented without departing from the spirit and scope of the present invention. For example, the trigger 110 may also be biased such that the trigger 110 is inwardly depressible, relative to the tool 100, to cause the tool 100 to operate, and a release of the trigger 110 causes the trigger 110 to move outwardly, relative to the tool 100, to cease operation of the tool 100 via the biased nature of the trigger 110. The trigger 110 and switch mechanism 118 may also be a variable speed type mechanism. In this regard, actuation or depression of the trigger 110 causes the motor to operate at a faster speed the further the trigger 110 is depressed.

The motor 114 may be disposed in the tool housing 102 and be adapted to operably engage the output assembly 104, and provide torque to the tool 100 and, in turn, to the drive portion 106/drive lug 108. The motor 114 may be a brushless or brushed type motor, or any other suitable motor. A power source 120 can be associated with the tool 100 to provide electronic or other forms of power to the tool 100, such as, for example, electric, hydraulic, or pneumatic, to operate the motor. In an embodiment, the power source 120 can be housed in an end 112 of the tool housing 102, opposite the output assembly 104, a midsection of the tool 100, or any other portion of the tool 100/tool housing 102. The power source 120 may also be an external component that is not housed by the tool 100, but that is operatively coupled to the tool 100 through, for example, wired or wireless means. In an embodiment, the power source 120 is a removable and rechargeable battery that is adapted to be disposed in the end of the tool housing 102 and electrically couple to corresponding terminals of the tool 100.

The controller 116 may be operably coupled to one or more of the power source 120, switch mechanism 118, indicator 122, and the motor 114, and adapted to control power supplied to the motor 114 from the power source 120. The controller 116 may include a central processing unit (CPU) for processing data and computer-readable instructions, and a memory for storing data and instructions. The memory may include volatile random access memory (RAM), non-volatile read only memory (ROM), and/or other types of memory. A data storage component may also be included, for storing data and controller/processor-executable instructions (for example, instructions for the operation and functioning of the tool 100). The data storage component may include one-or-more types of non-volatile solid-state storage, such as flash memory, read-only memory (ROM), magnetoresistive RAM (MRAM), ferroelectric RAM (FRAM), phase-change memory, etc.

Computer instructions for operating the tool 100 and its various components may be executed by the controller 116, using the memory as temporary “working” storage at runtime. The computer instructions may be stored in a non-transitory manner in non-volatile memory, storage, or an external device. Alternatively, some of the executable instructions may be embedded in hardware or firmware in addition to or instead of in software.

For example, the controller 116 may implement of the methods described herein. When the trigger 110 is unintentionally actuated, power is provided to the motor 114 to cause the output assembly 104 to operate. In this situation, the controller 116 determines when the motor 114 is running at any nonzero speed and/or no resistance or torque is applied to the output assembly 104, or the trigger is otherwise unintentionally actuated, and initiates or starts a motor timer. If the trigger 110 remains continuously actuated, with the motor 114 running at any nonzero speed and/or no resistance or torque applied to the output assembly 104, or the trigger is otherwise unintentionally actuated, and the motor timer reaches a threshold limit (such as 2 minutes), the controller 116 causes discontinuance of power to the motor 114, thereby shutting off the motor 114. The controller 116 may also cause the indicator 122 to activate and indicate a fault to the user, thereby indicating that the trigger 110 was unintentionally actuated. After a period of time (such as 5 to 10 seconds), the controller 116 may cause the indicator 122 to be deactivated to conserve power. When the trigger 110 is released and pulled again or the power source removed, the controller 116 can cause the tool to resume normal operation and reset the motor timer. The indicator 122 may be any type of indicator, such as a light emitting diode (LED), haptic actuator, display, etc. that is capable of indicating the fault to the user.

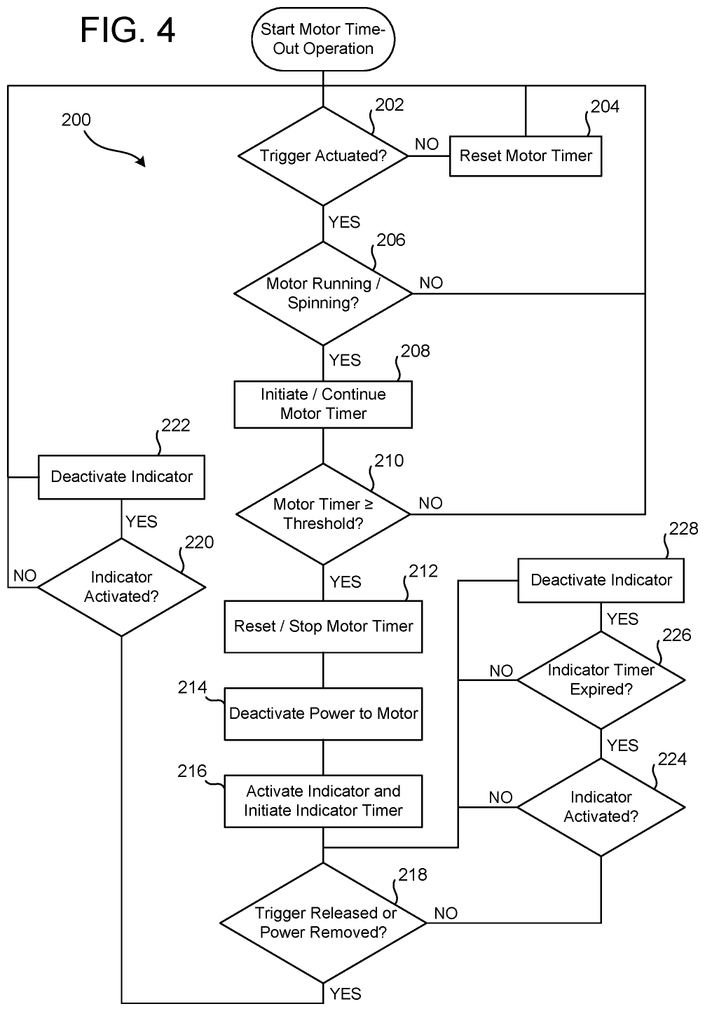

Referring to FIG. 4, a method 200 of operation of the tool 100 is described. The method begins when the trigger is actuated, illustrated as block 202. When the trigger is not actuated, a motor timer may be reset (if the motor timer is at a nonzero time), illustrated as block 204. When the trigger is actuated, the tool (such as via controller 116) determines whether the motor is running at any nonzero speed, illustrated as block 206, or the trigger is otherwise unintentionally actuated.

When the motor is not running, the method proceeds back to block 202 to determine whether the trigger is actuated. When the motor is running at any nonzero speed, or the trigger is otherwise unintentionally actuated, the tool (such as via controller 116) initiates/starts or continues a motor timer, illustrated as block 208. The tool (such as via controller 116) determines whether the motor timer is greater than or equal to a threshold (such as 2 minutes), illustrated as block 210. When the motor timer is less than the threshold (such as 2 minutes), the method proceeds back to block 202 to determine whether the trigger is actuated. When the motor timer is greater than or equal to the threshold (such as 2 minutes), the tool (such as via controller 116) resets and/or stops the motor timer, illustrated as block 212. The tool (such as via controller 116) ceases or deactivates power supplied to the motor, illustrated as block 214, and may also activate the indicator and initiate an indicator timer, illustrated as block 216.

Once the tool (such as via controller 116) ceases or deactivates power supplied to the motor, the tool (such as via controller 116) may determine whether the trigger has been released or the power source removed, illustrated as block 218. When the trigger is released or the power source removed, the tool (such as via controller 116) may determine whether the indicator is activated, illustrated as block 220. When the indicator is activated, the tool (such as via controller 116) may deactivate the indicator, illustrated as block 222, and the method may proceed back to block 202. When the indicator is not activated (for example, the indicator deactivated after a period of time (such as 5 to 10 seconds) to conserve power), the method may proceed back to block 202.

However, when the trigger has not been released or the power source removed, the tool (such as via controller 116) may determine whether the indicator is activated, illustrated as block 224. When the indicator is not activated or deactivated, the tool (such as via controller 116) may proceed back to block 218. When the indicator is activated, the tool (such as via controller 116) may determine whether the indicator timer is expired or has reached a time threshold (such as 5 to 10 seconds), illustrated as block 226. When the indicator timer is not expired or has not reached the time threshold, the tool (such as via controller 116) may keep the indicator activated and proceed back to block 218. When the indicator timer is expired or has reached the time threshold, the tool (such as via controller 116) deactivate the indicator, illustrated as block 228, and the method may proceed back to block 218.

The implementation of the motor timer and shut-off reduces the chance of the power source being unintentionally discharged, when the tool is stored in a bag, tool box, vehicle, or other storage mechanism. The motor timer and shut-off also reduces the chance of the tool creating a situation where the output assembly can unintentionally cause damage to the storage mechanism or other surroundings.

As discussed herein, the tool 100 is a ratchet-type wrench. However, the tool 100 can be any type of hand-held motorized tool, including, without limitation, electrically powered or motorized tools, such as a drill, router, or impact wrench, ratchet wrench, screwdriver, or other powered tool, that is powered by electricity via an external power source (such as a wall outlet and/or generator outlet) or a battery.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A method of operating a tool having a motor, a trigger, and a power source adapted to supply power to the motor, comprising:
determining whether power is being supplied to the motor by the power source;
if power is being supplied to the motor, initiating a motor timer; and
causing power being supplied to the motor to stop when the motor timer meets or exceeds a motor time threshold.

2. The method of claim 1, further comprising:
activating an indicator of the tool when the motor timer meets or exceeds the motor time threshold; and
initiating an indicator timer.

3. The method of claim 2, further comprising:
before initiating the motor timer, determining whether the trigger of the tool is actuated; and
after the power being supplied to the motor is stopped, determining whether the trigger remains actuated.

4. The method of claim 3, further comprising deactivating the indicator when the indicator timer meets or exceeds an indicator time threshold when the trigger remains actuated.

5. The method of claim 3, further comprising deactivating the indicator when the trigger is not actuated.

6. The method of claim 2, further comprising:
before initiating the motor timer, determining whether the trigger of the tool is actuated; and
after the power being supplied to the motor is stopped, determining whether the power source is decoupled from the tool.

7. The method of claim 6, further comprising, deactivating the indicator when the indicator timer meets or exceeds an indicator time threshold when the power source is coupled to the tool.

8. The method of claim 6, further comprising, deactivating the indicator when the power source is decoupled from the tool.

9. A tool, comprising:
a motor;
a power source adapted to supply power to the motor; and
a controller adapted to:
determine the motor is being supplied with power from the power source;
initiate a motor timer; and
stopping a supply of power to the motor when the motor timer meets or exceeds a motor time threshold.

10. The tool of claim 9, further comprising an indicator, and wherein the controller is further adapted to:
activate the indicator when the motor timer meets or exceeds the motor time threshold; and
initiate an indicator timer.

11. The tool of claim 10, further comprising a trigger that, when actuated, causes the power source to supply the supply of power to the motor, and wherein the controller is further adapted to:
determine the trigger is actuated, before initiating the motor timer; and
determine whether the trigger remains actuated, after stopping the supply of power to the motor.

12. The tool of claim 11, wherein the controller is further adapted to deactivate the indicator when the indicator timer meets or exceeds an indicator time threshold, when the trigger remains actuated.

13. The tool of claim 11, wherein the controller is further adapted to deactivate the indicator, when the trigger does not remain actuated.

14. The tool of claim 10, further comprising a trigger that, when actuated, causes the power source to supply the power to the motor, and wherein the controller is further adapted to:
determine whether the trigger is actuated, before initiating the motor timer; and
determine whether the power source is decoupled from the tool, after stopping the supply of power to the motor.

15. The tool of claim 14, wherein the controller is further adapted to deactivate the indicator when the indicator timer meets or exceeds an indicator time threshold, when the power source is coupled to the tool.

16. The tool of claim 14, wherein the controller is further adapted to deactivate the indicator, when the power source is decoupled from the tool.

17. The tool of claim 9, wherein the controller includes a data storage component storing executable instructions.

18. The tool of claim 17, wherein data storage component is a ferroelectric random access memory (FRAM).
